(19) United States
(12) Patent Application Publication
(10) Pub. No.: US 2010/0290663 A1
(43) Pub. Date: Nov. 18, 2010

(54) MORPHOLOGIC SAFETY FEATURE

(75) Inventors: Stepahn Trassl, Kemnath (DE); Peter Reich, Pirk (DE); Andreas Reil, Hirschau (DE); Udo Kroczynski, Weiden (DE)

Correspondence Address: WENDEROTH, LIND & PONACK, L.L.P., 1030 15th Street, N.W.,, Suite 400 East, Washington, DC, 20005-1503, US

(73) Assignee: CONSTANTIA HUECK FOLIEN GMBH & CO. KG

(21) Appl. No.: 12/451,658

(22) PCT Filed: May 21, 2008
(86) PCT No.: PCT/EP2008/004055

§ 371 Date: Apr. 22, 2010

(30) Foreign Application Priority Data
May 24, 2007 (EP) 07010317.1

(51) Int. Cl. G06K 9/00

(52) U.S. Cl. 382/100

(57) ABSTRACT

The invention relates to a safety feature, comprising a carrier substrate onto which a continuous-tone image is printed, characterized in that the continuous-tone image is transferred into a high-resolution bar element by a morphologic transition.

The invention relates to a morphological security feature which can be used as a security element in documents of value and packaging.

Morphological image processing is a method from computer-aided image manipulation.

It uses methods for finding neighborhoods, in order to consider the environment of an image point and, following from this, to carry out operations. For instance, attempts are made to lay a bit mask (the structuring element) (small relative to the image) on an image in such a way that all the image points of the initial image lying underneath have the same value as those which are defined in the mask. All the points which are not the center of the mask placed suitably in any position are deleted (“erosion”).

By means of a suitable selection of the structuring element, specific image regions can be emphasized with respect to others, for example horizontal or vertical structures.

A further morphological method in graphic image processing is dilation, in which the precondition for an action is that at least one pixel of the structuring element touches a pixel of the original image. In this case, in the original image the image points around the center are expanded by the image points defined in the mask.

Digital image processing is the computer-aided processing of digital images, usually of halftone graphics, normally photos or scanned documents. These images are subsequently changed in order to optimize them, to make them unfamiliar, to modify them or to manipulate them, with the objective of achieving a desired result.

While gray value halftone images are usually represented as a map of coordinate pairs on color values, for binary images a representation as a set of set pixels is recommended. Operations can then be described as a set operation between the sets of halftone points from the binary image and a structuring element. From the basic operations of morphological image processing, erosion and dilation, the operations comprising opening, closing and finally morphological smoothing can be defined.

By means of smoothing, the image noise can be reduced; on the other hand coarser structures are maintained. Here, an example for an image made (artificially) noisy. On the basis of the frequency spectrum of an image, smoothing equates to a low pass filter. Typical FIR smoothing filters are
Mean-value filters (box filters): a mean-value filter of size n×m is described by an n×m pulse response matrix gₙₘ=(nm)⁻¹. The image points of the transformed image are thus the mean values of their n×m neighbors. Box filters are not isotropic and non-decaying and, as opposed to a naive estimation, do not represent an actual low pass filter.
Gauss filters: Gauss filters of size n×m and variance σ² are described by a pulse response matrix

$${g}_{nm} = \frac{1}{σ \sqrt{2 π}} {e}^{- \frac{{n}^{2} + {m}^{2}}{2 {e}^{2}}} .$$

The neighboring points of the initial image are therefore not included with the same value, as in the case of the box filter, but are weighted in accordance with a two-dimensional Gauss distribution. Gauss filters are therefore isotropic and decaying. They are used as a real optical component as a Gauss filtering of the Fourier transforms in the apodisation (example).
Non-linear smoothing filters; in this case the gray value of the current pixel is replaced by
   median filter
      the median of the gray values from the current environment (example)
   k-centered mean
      the average of the k-centered gray values
   k-NN filter
      the median of the k-nearest gray values from the environment
   δ-neighborhood filter
      the average of all the gray values whose distance is less than d from the current gray value
   Lee's filter

$${h}_{nm} = {μ}_{nm} + ( {f}_{nm} - {μ}_{nm} ) \cdot \frac{{S}_{nm}^{2} - {σ}^{2}}{{S}_{nm}^{2}}$$

μₙₘ is the gray value average, Sₙₘ² the gray value variance and σ² the noise energy of the current environment
minimum variance filter
   the gray value averages μᵢ and variances Sᵢ² of some partial windows are calculated
   hₙₘ=μⱼ is selected with Sⱼ²=minᵢ{Sᵢ²}

If, instead of the absolute color values, the deviation from the adjacent points is signaled, then the object contours, which means the hard color transitions, of an image are emphasized, while soft transitions are attenuated. This procedure is designated edge emphasis.

The following FIR filters are often applied:
Derivative filter
Laplace filter

Non-linear edge detectors:
Variance filter
Extreme span filter
Roberts cross
Kirsch filter
Gradient filter
   Prewitt filter
   Sobel filter
   Canny filter

If images are represented as a sequence of color values, one speaks of a representation in the time domain, pulse domain or else location domain. From the latter, images can be transferred injectively into what is known as the frequency domain, in which it is no longer the color values themselves but the frequency and phase components of the basic sequence of points that are stored. Large jumps within the color value sequence then represent high frequencies, soft color value transitions low frequencies. The Fourier transform ultimately indicates how, by means of only superimposing sinusoidal functions of different frequency and phase angle, the original color value variation can be reconstructed.

The advantage of this representation lies in its higher efficiency during the application of linear filters. In the pulse domain, the convolution of the color value sequence fᵢ describing the image with the pulse response g_{μ} (the transform mapping) of the filter means a summation (of the weighting of the pulses with the pulse response) over the entire filter length. In the frequency domain, on the other hand, the convolution is calculated as the product of the Fourier transform with the frequency response of the transform ℑ. This advantage with respect to the computational time is so great that even the effort for the forward and reverse transformation into the frequency domain can be accepted. This effort can be reduced considerably with the aid of the fast Fourier transformation (FFT).

Also advantageous is the simplification of being able to design filters directly in the frequency domain instead of having to construct pulse responses and to calculate their effect on the spectrum. Therefore, the transformation of the pulse response gₖ into the associated frequency response G(z) is as it were rendered superfluous.

The object of the invention was to provide a security feature that can be implemented by printing in a forgery-proof manner, it being possible to use standard inks in addition to specific security inks.

The subject of the invention is therefore a security feature having a carrier substrate onto which a halftone image is printed, characterized in that the halftone image is transferred into an extremely high-resolution bar element by a morphological transition.

A further subject of the invention is film materials which have a security feature according to the invention.

Here, the morphological image processing is not carried out in a manner corresponding to the prior art between two pixel images; instead morphological processing is carried out between pixel image and vector image.

Suitable as a carrier substrate are, for example, carrier films, preferably flexible plastic films, for example of PI, PP, MOPP, PE, PPS, PEEK, PEK, PEI, PSU, PAEK, LCP, PEN, PBT, PET, PA, PC, COC, POM, ABS, PVC. The carrier films preferably have a thickness from 5-700 μm, preferably 8-200 μm, particularly preferably 12-50 μm.

Furthermore, the carrier substrates used can also be metal foils, for example Al, Cu, Sn, Ni, Fe or stainless steel foils with a thickness from 5-200 μm, preferably 5 to 80 μm, particularly preferably 5-50 μm. The foils can also be surface-treated, coated or laminated, for example with plastics, or varnished.

Furthermore, the carrier substrates used can also be paper or composites with paper, for example composites with plastics having a weight per unit area of 20-500 g/m², preferably 40-200 g/m².

Furthermore, the carrier substrates used can also be woven fabrics or nonwovens, such as endless fiber nonwovens, staple fiber nonwovens and the like, which may possibly be needled or calendered. Preferably, such woven fabrics or nonwovens consist of plastics, such as PP, PET, PA, PPS and the like, but woven fabrics or nonwovens of natural, possibly treated, fibers, such as viscose fiber nonwovens, can also be used. The woven fabrics or nonwovens used have a weight per unit area from about 20 g/m² to 500 g/m². If appropriate, these woven fabrics or nonwovens can be surface-treated.

A printed halftone image is transferred by a morphological transition into an extremely high-resolution bar element, which can be defined mathematically.

A transition is therefore obtained between a screened image (printable pixel image) and a vector graphic (line work) and vice versa.

The use of a printing screen is a method from the prepress stage within printing technology. Presses usually have a specific, very limited selection of inks which they are able to print exclusively purely. Most printing processes are thus not able to represent any halftones (apart, for example, from variable-depth or variable surface-depth gravure printing and NIP processes). The problem is that either an ink dot can be printed at a point or not. It is not possible to control whether little ink or much ink is printed at an image point. As a solution, texts, images and graphics —if these do not consist exclusively of the pure printing inks—are screened in order to represent various gray stages or hues. In order to be able to represent mixtures between the printing inks or various lightnesses of the latter, very fine printed dots of the inks are printed beside one another/over one another in order to achieve the desired resultant color impression.

During screening, image data is converted into specified printing data. In the process, binary information (print/do not print) is calculated from halftone originals. The impression of hue values and gray stages is achieved by means of a suitable arrangement of continuous-tone dots (screen dots).

If, about 30 years ago, halftone effects were achieved by means of glass gravure screens or specific screening film sheets, nowadays use is made of specific imagesetters (laser exposers) which operate with software developed specifically for the purpose, the “RIP” (raster image processor). During the RIP process, generated data (PS or PDF files, etc.) is converted into printable pixel (images) or vector data (line work).

The screen frequency (also called the screen width) is a measure of the resolution of printing screens. The screen frequency indicates how many printed dots occur per unit length. Here, a distinction is drawn between:
Amplitude-modulated screens, which use the same number of points for all tonal values and produce darker colors by means of larger dots.
Frequency-modulated screens, which always use equal-sized halftone dots but change their number depending on the tonal value, therefore produce darker colors by means of more dots.

Normal screen frequencies (also called the screen width) in newspaper printing are 30-54 dots per cm, 54-80 dots per cm in offset printing, up to 120 dots per cm in high-value printed products.

Depending on the technical conditions, it is possible or necessary to apply different types of screening.

On an area of, for example, 16×16 exposer points, a halftone pixel is assembled. The more exposer pixels are found on this #16 square, the darker the effect of the point. If, however, only fewer exposer points are collected in the square, the effect of the point from a distance is light.

The screen width is the spacing of the individual screen cells. From this, the screen frequency is calculated as the reciprocal of the screen width. The number of screen cells per unit distance is specified in lines per centimeter or lines per inch (lpi).

Common values in offset printing are 54 to 80 lines/cm (about 135 to 200 lpi) and, in newspaper printing, 30 to 54 lines/cm.

In an exposer having 2540 dpi or 1000 ppcm: 1000/16=62.5=>a #60 screen.

During the exposure, the individual halftone dots are assembled from a plurality of laser spots.

Since technical limits are placed on the size of halftone dots that can be reproduced in the print, it is primarily the smallest tonal values that cannot be reproduced in the common screen widths. A further problem is the undesired joining of halftone dots lying beside one another (dot coalescence), which can lead to an abrupt rise in the tonal value density where a uniform rise is actually desired.

In four color printing, in which a plurality of screen angles have to be overprinted in order to represent a color image, attempts are made to control this effect by means of different angles of the color separations. Usual screen angles in the case of four color offset printing are, according to DIN 16 547, firstly yellow=0°, cyan=75°, black=135°, magenta=15° or yellow=0°, cyan=15°, black=45°, magenta=75°.

In principle, amplitude-modulated (autotypical screens) and frequency-modulated (stochastic screens) methods can be distinguished.

In the case of amplitude-modulated screening, in order to produce different tonal values, the size is varied; in the case of frequency-modulated screening (non-periodic method of 1st order), the number of halftone dots per raster cell is varied.

Frequency-modulated screening could be implemented in practice only with the introduction of computer-to-plate technology, that is to say the direct imaging of the digital database on the offset printing plate. Previously, on account of the fineness of the halftone dots (between 10 and 30 micrometers), a transfer from the film to the printing plate was not reliably possible. This screening technique permits greater fineness of the resolution, prevents Moiré and permits a color gamut in the offset print which is expanded by about 7 percent. In addition, the amount of ink can be reduced with the same coloring effect, which is associated with advantages during the drying operation and in the consumption of ink.

In addition, a combination of the two methods (non-periodic method of 2nd order) and a change in the halftone dot shape (non-periodic method of 3rd order) is possible.

Screens can be produced by photographic methods (analog) or electronically (digital).

Analog methods are distance screening and screening with the aid of a contact screen in the reprographic camera. However, both methods are to be met only rarely nowadays.

The electronic screen production is carried out with what is known as a raster image processor (RIP). The transfer of data to the RIP is mostly carried out as a PostScript file.

A raster image processor is a specific hardware unit or a combination of hardware and software, which converts specific data from a higher page description language, for example PostScript, PDF (also VPS, AFP) or PCL into a halftone graphic, as a rule to output the latter subsequently on a printer.

A raster image processor implements substantially two functions:
1. Conversion of vector graphics into halftone graphics of specific resolutions
2. Recalculation of halftone graphics for the purpose of conversion to other resolutions or sizes

Explicitly, the term raster image processor is common only in the prepress stage and/or in reproduction technology and there means a specific component in the printing process which, in addition to the aforementioned functions, performs further tasks:
Color management
OPI image replacement
Separation
Trapping

The most widespread printing screen is the PostScript screen. It is used by virtually all presses and also by laser printers. In this screen, color steps of individual inks are produced by the color being broken down into a screen of rows and lines of individual dots perpendicular to one another. The desired lightness of the color is determined by the diameter of the individual, circular printed dots. The lighter the individual color is to be printed, the smaller is the diameter of the relevant printed dot. This is simulated in the photographic screen. In the conventional four color print, the halftones of the individual colors are overprinted with an angular offset of 30° in relation to one another.

Halftone pictures or halftone images exhibit colors running into one another with every possible tonal graduation, that is to say from the deepest black to the lightest gray, from the lightest hue to the darkest. As a rule, photographs are halftone pictures.

In a halftone image, as opposed to the line image or to the continuous-tone image, there are lightness gradations of the motif in a tonal value scale from white to black (gray-scale image). The (logarithmic) measure of the lightness difference between the lightest and the darkest (blackest) tonal value (light to shadow) is called gradation, measured in gamma. If the gradation is low, the image is called soft, in the extreme case insipid, if it is high, the effect of the image is hard (i.e. very contrast-rich).

In the event of a reduction in the tonal values to a few, the poster effect occurs (US English: posterized image; posterization). If only two tonal or color values remain, this is a line image.

If halftone pictures are reproduced in print, the original must be broken down (screened) into halftone dots by means of a screen during the image reproduction, which means that a screened image is in principle a line image which feigns a halftone image.

A vector graphic is a computer image which is assembled from graphic primitives such as lines, circles and polygons.

In order, for example, to store the image of a circle, a vector graphic needs at least two values: the position of the center of the circle and the circle diameter. In addition to the intrinsic parameters (shape and position) of the primitives, possibly also the color, line thickness, diverse filling patterns and further data determining the appearance will be specified.

As opposed to halftone graphics, vector graphics can be scaled and broken down continuously without any loss of quality, for example by means of homogenous coordinates. In addition, in vector graphics the properties of individual lines, curves or surfaces are maintained and can also still be changed subsequently.

Pure vector graphics were considered for a long time to be unsuitable for the representation of photo-realistic graphics, since at the start it was barely possible to model these mathematically. In the meantime, however, current vector graphic programs offer functions which permit vector drawings to be stored together with anti-alias effects, fine color variations and transparencies and in this way photo-realistic results to be produced. The graphics generated nevertheless remain capable of being scaled and changed.

The creation of vector graphics is normally carried out by means of a vector graphic program or directly by using a drawing language. With certain restrictions, halftone graphics can be converted into vector graphics (vectorization).

In order to create illustrations, vector-based drawing programs can be used. CAD programs are used for technical drawings. 3-D modeling tools produce 3-D vector graphics for scenes within the context of 3-D computer graphics.

Vector graphics permit documents to be described irrespective of the resolution of the output device. With the aid of a vector graphic-capable page description language such as PostScript or the portable document format (PDF) which originated therefrom, documents can be displayed on screens or printed with the respective highest possible resolution.

On current computer systems, what are known as outline fonts are predominantly used nowadays, which describe the outlines of each character as a vector graphic. Important formats are TrueType, PostScript and OpenType.

A halftone image (scan, digital photograph, drawing, 3-D object, etc.) is therefore transferred into a vector graphic or vice versa. From a halftone image (Adobe Photoshop program), the necessary base area is created in the form of a contour, in which a morphological feature is incorporated as a vector graphic (TIFF, EPS format). The TIFF or EPS format created in the Adobe Photoshop program is transferred in the Barco Fortuna program as a vector graphic.

The basic shape created is processed mathematically with guilloches variably in terms of line thickness, number of lines, shape and color and fed back into the halftone image again (as EPS or PDF format).

During the processing in the halftone image (Adobe Photoshop program), the vector graphic is adapted as a total image.

The transition can in this case be represented linearly, radially, frequency-modulated, depth-modulated, etc.

The processing of the halftone image is carried out, for example, with the Adobe Photoshop program. The processing is usually carried out in the TIFF format but can also be carried out in the native Photoshop format. The export of the halftone file always relates, however, to open file structures, for example TIFF, JPEG, RAW, etc.

The processing of the vector graphics is carried out with, for example: Barco Fortuna, Adobe Illustrator or Artwork Artpro. However, other vector-based graphic programs can also be used.

The halftone image can be represented with different halftone forms (points, squares, crosses, etc.). In this case, the screen width is in particular preferably 1 lpi to 10,000 lpi, particularly preferably 10 lpi to 1000 lpi, quite particularly preferably 100 lpi to 500 lpi. The screen angle is preferably 0°-90° (according to CMYK).

The vector graphic is adapted to the size, shape, modulation, etc. of the halftone image.

This adaptation of the vector graphic, which can also be described by a mathematical formula, such as a guilloche function or a polygon function, is carried out via parameters such as amplitude, frequency, modulation or number of reference points.

If the vector graphic is described by a linear screen, the adaptation to the halftone image can be carried out for example via the screen width, screen angle, screen frequency or the line thickness.

Conversely, the halftone image can also be adapted to the vector graphic. To this end, for example, the halftone image can be broken down by tonal value steps, for example for highlights, ¼ tones, ½ tones, ¾ tones and depths. An adaptation can then be carried out, for example, via various screen shapes, screen angles, screen frequencies.

The morphological transition can also be carried out repeatedly or only in specific subregions, such as only in the depths or only in the highlights of a halftone image.

Suitable printing processes are known printing processes, such as gravure, flexographic, screen, offset or digital printing. Here, conventional printing inks but also special inks, such as IR or UV inks, can be used.

The security features according to the invention are suitable for use in data carriers, in particular documents of value such as identity papers, cards, banknotes or labels, seals and the like, but are also suitable as packaging material, for example in the pharmaceutical, cosmetic, electronic and/or foodstuffs industry, for example in the form of blister films, folded boxes, coverings, film packaging and the like.

For the application as security features, the substrates or the film materials are preferably cut into strips or threads or patches, it being possible for the width of the strips or threads preferably to be 0.05-10 mm and for the patches preferably to have average widths and lengths of 2-30 mm.

For the application in or on packaging, the film material is preferably cut into strips, tapes, threads or patches, the width of the threads, strips or tapes being 0.05-600 mm, preferably 50-150 mm, and the patches preferably having average widths and lengths of 2-100 mm.

However, it is also possible to print the security features described directly onto primary packaging, such as board, films, aluminum, blisters and the like or directly onto documents of value.

1. A security feature having a carrier substrate onto which a halftone image is printed, characterized in that the halftone image is transferred into an extremely high-resolution bar element by a morphological transition.

2. The security feature as claimed in claim 1, characterized in that the bar element is defined mathematically.

3. The security element as claimed in claim 2, characterized in that the bar element is defined by a guilloche function or a polygon function.
